(19) United States
(12) Patent Application Publication
(10) Pub. No.: US 2012/0329958 A1
(43) Pub. Date: Dec. 27, 2012

(54) POLYMER SYNTHESIS AND THERMALLY REARRANGED POLYMRES AS GAS SEPARATION MEMBRANES

(75) Inventors: Benny D. Freeman, Austin, TX (US); David Sanders, Austin, TX (US); Claudio P. Ribeiro, JR., Houston, TX (US); Zachary Smith, Austin, TX (US); James E. McGrath, Blacksburg, VA (US); Ruilan Guo, Mishawaka, IN (US)

(73) Assignees: Virginia Tech Intellectual Properties, Inc., Blacksburg, VA (US); Board of Regents, The University of Texas System, Austin, TX (US)

(21) Appl. No.: 13/486,572

(22) Filed: Jun. 1, 2012

Related U.S. Application Data
(60) Provisional application No. 61/492,312, filed on Jun. 1, 2011.

(51) Int. Cl. C08G 73/10; C08G 73/22

(52) U.S. Cl. 525/425; 525/434

(57) ABSTRACT

The present invention includes a polymer formed by the thermal rearrangement of an ortho-functional polyimide synthesized via chemical imidization with permeation properties for gas separation membranes higher than those synthesized via thermal imidization and a method for forming that polymer having tailored transport properties and different chemical resistance. The present invention also includes a polymer formed by the thermal rearrangement of an ortho-functional polyimide in which a portion of the ortho-position functional group is lost during thermal rearrangement to yield a thermally rearranged polymer with higher permeability than would be seen without the ortho-position group. This ortho-position group can be the result of chemical imidization, or the result of a post-imidization modification reaction.

### CROSS-REFERENCE TO RELATED APPLICATIONS

This application claims priority to U.S. Provisional Application Ser. No. 61/492,312, filed Jun. 1, 2011, the contents of which are incorporated by reference herein in its entirety.

### STATEMENT OF FEDERALLY SPONSORED RESEARCH OR DEVELOPMENT

This invention was made with government support under Grant No DE-FG02-02ER15362 awarded by the Department of Energy. The government has certain rights in the invention.

### TECHNICAL FIELD OF THE INVENTION

The present invention relates in general to the field of gas separation membranes, specifically to compositions of matter and methods of making and using thermally rearranged polymers as gas separation membranes.

### INCORPORATION-BY-REFERENCE OF MATERIALS FILED ON COMPACT DISC

None.

### BACKGROUND OF THE INVENTION

Without limiting the scope of the invention, its background is described in connection with polymers formed by the thermal rearrangement of an ortho-functional polyimide. Polymeric membranes have been used to separate, remove, purify or partially recover a variety of components from mixtures, e.g., gases including hydrogen, helium, oxygen, nitrogen, argon, carbon monoxide, carbon dioxide, ammonia, water vapor, methane and other light hydrocarbons. Generally, this separation is dependent on the permeability and the selectivity of the polymer for the molecules. For example, one of the components may selectively permeate through the polymer and/or diffuse through the polymer more readily than another component of the mixture; whereas a relative non-permeating component passes less readily through the polymer than other components of the mixture.

The separation of diffusants (e.g., molecules or compounds) using a polymer is dependent on properties of both the polymer and the diffusants. Therefore, there are many factors that influence diffusion including, for example, the effective molecular size of the diffusant, the intermolecular interactions of the diffusant with itself and with the polymer, the composition of the polymer, the morphology of the polymer, the local scale segmental mobility of the polymer segments, and the degree of departure of the polymer from equilibrium chain packing

Natural gas purification is one of the largest gas separation applications in the world. Nearly 100 trillion scf of natural gas is produced worldwide each year, and approximately 17% of that requires treatment for CO₂. While membranes control less than 5% of the market, improving membrane permeability, selectivity, and chemical resistance can greatly increase this market share.¹

In spite of the considerable research in separation membranes and polymers, there have been limited advances in gas separation membranes. Furthermore, increases in selectivity for one gas over another are generally obtained at the expense of decreases in permeability. Additionally, many polymers that exhibited attractive combinations of permeability and selectivity in single gas measurements have failed to show similar properties when tested in gas mixtures due to phenomena such as plasticization, which can sharply reduce selectivity as the concentration of dissolved gas in the polymer increases, typically with increasing feed pressure. The synthesis of polybenzoxazoles by thermal rearrangement of polyimide was documented as early as the 1960's.²⁻⁵ Polybenzoxazoles were expected to have desirable properties for gas separation membranes, but no systematic gas separation testing was reported prior to 2007 due, at least in part, to the insolubility of these films, which strongly hinders their ability to be prepared as thin membranes.⁶ Since this discovery, work has continued on polybenzoxazoles as well as other thermally rearranged polymers.⁷⁻⁹ Critical properties for natural gas purification include high CO₂ permeability and CO₂/CH₄ selectivity in addition to good chemical resistance, which prevents polymers from plasticizing in the presence of CO₂, which would typically lower selectivities under normal operating conditions.

### BRIEF SUMMARY OF THE INVENTION

The present inventors recognized a need for a polymer formed by the thermal rearrangement of an ortho-functional polyimide with attractive properties for gas separation membranes. Those properties include high permeability for CO₂ and high CO₂/CH₄ selectivity as well as strong chemical resistance to restrict polymers from plasticizing in the presence of CO₂ or other components in natural gas, such as heavy hydrocarbons. In accordance with the present invention, a method for synthesizing a polyimide by chemically imidizing a poly(amic acid) is provided. The resulting polyimide may be thermally rearranged to form a so-called TR polymer, often in the form of a polybenzoxazole. The combination of TR polymers and chemical imidization methods provide compositions having a synergistic effect with the resulting properties being different from those of polybenzoxazoles prepared by traditional (i.e., non-TR) methods. An additional advantage of this approach, over that of beginning with an insoluble polybenzoxazole, is that thin membranes could be fabricated from the soluble polyimide precursors using standard solution processing methodologies commonly known in the art to prepare thin membranes for gas separation applications and then converting the resulting polyimide membrane into a TR polymer membrane in a post-membrane fabrication thermal treatment process. The resulting TR membrane would be insoluble and very stable chemically, but it would have been prepared from a readily soluble precursor, which permits rapid fabrication of thin membranes using well-known technology.¹⁰

The present invention provides a method for synthesizing a thermally rearranged polymer (e.g., a polybenzoxazole, or polybenzothiazole) by forming a poly(amic acid) from at least one diamine monomer containing an ortho-position functional group; forming an aromatic polyimide with an ortho-functional group by imidization of the poly(amic acid); rearranging the aromatic polyimide with an ortho-functional group to form a thermally rearranged aromatic polyimide having an ortho-functional group void, wherein the ortho-functional group includes an O or S linkage to a second group that is lost during thermal rearrangement and the thermally rearranged aromatic polyimide having an ortho-functional group void has properties influenced by the ortho-functional group void.

The present invention also provides a method for synthesizing a thermally rearranged polymer by forming an aromatic polyimide having the structure:

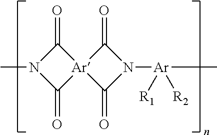

wherein Ar is a first aromatic group having an ortho-positioned functional group R1 and R2 and Ar′ is a second aromatic group; and heating the aromatic polyimide to a temperature between about 300° C. and about 550° C., whereupon a chemical reaction occurs that results in rearranging the polymer material to form a thermally rearranged polymer having the structure:

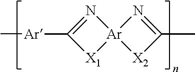

wherein X₁ and X₂ are either O or S and the thermally rearranged polymer has ortho-positioned functional group voids. For example, the aromatic polyimide could comprise a 3,3′-dihydroxy-4,4′-diamino-biphenyl (HAB) diamine and a 2,2′-bis-(3,4-dicarboxyphenyl)hexafluoropropane dianhydride (6FDA). Another example includes the aromatic polyimide having the following formula:

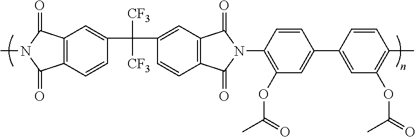

and its thermally rearranged analog having the following formula:

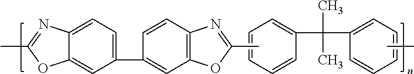

The present invention provides a method for synthesizing a thermally rearranged polymer membrane by forming an ortho-position functionalized poly(amic acid) from a diamine monomer having ortho-positioned functional groups and a dianhydride monomer; forming an ortho-functionalized polyimide with ortho-functional groups by imidization of the ortho-functionalized poly(amic acid); casting the polyimide in a polyimide film; drying the polyimide film and rearranging the ortho-functionalized polyimide with ortho-functional groups to form a rearranged polyimide having ortho-functional group voids that influence the properties of the rearranged polyimide.

The present invention provides a polymer having a thermally rearranged polymer comprising an ortho-functional group void spaces formed by rearrangement of a polyimide with ortho-functional groups, wherein the polyimide with ortho-functional groups comprises a diamine and a dianhydride to form an ortho-functionalized poly(amic acid) having ortho-positioned functional groups wherein the ortho-functionalized poly(amic acid) having ortho-positioned functional groups that has been cyclized with an imidization reaction and the ortho-functionalized polyimide with ortho-functional groups has been rearrange to form a rearranged polybenzoxazole having an ortho-functional group voids that influence the properties of the rearranged polyimide wherein the diamine and a dianhydride individually comprise a first aromatic selected from

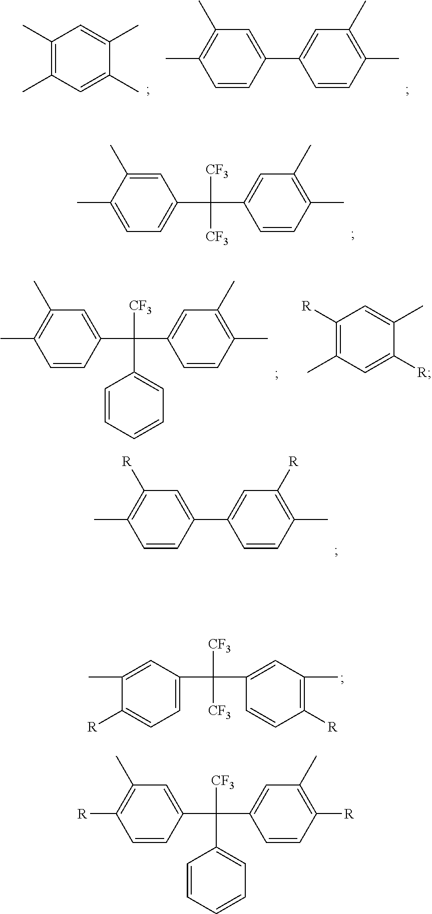

wherein R is

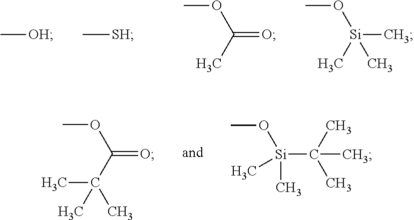

and a second aromatic selected from

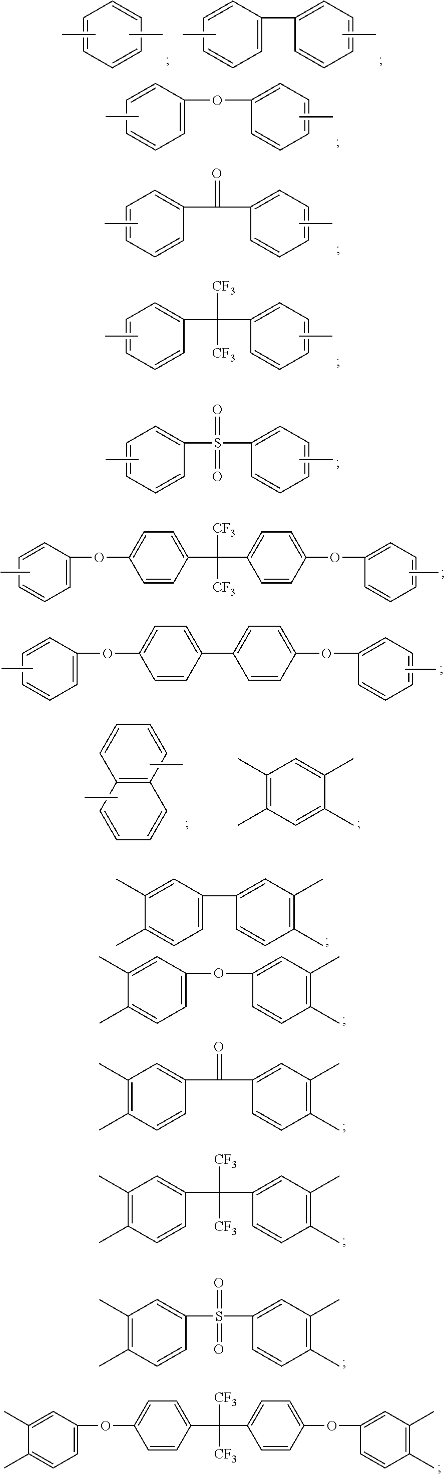

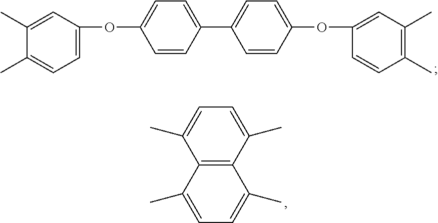

wherein R is

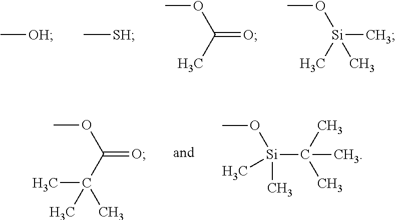

The present invention provides a polymer membrane having a rearranged polyimide with ortho-functional group void spaces formed by rearrangement of a polyimide with ortho-functional groups. The polyimide may be formed by chemical or thermal imidization.

The present invention also includes a method for thermally rearranging a polyimide in a solid state by providing an ortho-functional polyimide precursor and thermally rearranging it into a polybenzoxazole composition.

The present invention includes a thermally rearranged polymer whose precursor was synthesized by chemical imidization wherein the polymer has a higher CO₂ permeability than a thermally rearranged polymer whose precursor was synthesized using the ester acid synthesis route and a significantly higher chemical resistance than one whose precursor was synthesized by the ester acid route.

### BRIEF DESCRIPTION OF THE SEVERAL VIEWS OF THE DRAWINGS

For a more complete understanding of the features and advantages of the present invention, reference is now made to a detailed description of the invention along with the accompanying FIGURES and in which:

FIG. 1 is an illustration of HAB-6FDA polyimide synthesis using chemical imidization;

FIG. 2 is an illustration of HAB-6FDA polyimide synthesis using an ester-acid precursor and thermally imidization;

FIG. 3 is a graph of the typical heating protocol for the thermal rearrangement of an HAB-6FDA polyimide;

FIG. 4 is an illustration of a polybenzoxazole structure of HAB-6FDA-TR achieved by heating both the chemically imidized and thermally imidized sample;

FIGS. 5A and 5B are graphs of CO2 permeability and selectivity as a function of conversion for HAB-6FDA-C () and HAB-6FDA-EA (); and

FIG. 6 is an illustration of a HAB-6FDA ortho-functional polyimide structure with varying ortho-position group R, where the ortho-position O linkage could also be replaced with an S linkage.

### DETAILED DESCRIPTION OF THE INVENTION

Even though CO₂ removal from natural gas is a primary interest for polymers formed by the thermal rearrangement of an ortho-functional polyimide, their chemical resistance makes them strong candidates for any application that takes place in an aggressive chemical environment that would otherwise degrade current polymer membranes. They may also prove to be of use in applications that do not involve chemically aggressive environments but where their superior permeability and selectivity characteristics, relative to that of conventional gas separation polymers, could be an advantage.

As used herein, the term “separation factor” refers to the separation for a membrane for a given pair of gases “a” and “b” is defined as the ratio of the permeability coefficient of the membrane for gas “a” to the permeability coefficient of the membrane for gas “b.”

The term polymer as used herein refers generally to rigid, glassy polymers, rubbery polymers or flexible glassy polymers. Glassy polymers are differentiated from rubbery polymers by the rate of segmental movement of polymer chains. Polymers in the glassy state do not have the rapid molecular motion that permits rubbery polymers to have their liquid-like nature and their ability to adjust segmental configurations rapidly over large distances (>0.5 nm). Glassy polymers exist in a non-equilibrium state with entangled molecular chains with immobile molecular backbones in frozen conformations. The glass transition temperature (T_{g}) is the dividing point between the rubbery or glassy state. Above the T_{g}, the polymer exists in the rubbery state; below the T_{g}, the polymer exists in the glassy state. Rigid, glassy polymers describe polymers with rather rigid polymer chain backbones that have limited intramolecular rotational mobility and are often characterized by high glass transition temperatures.

The polymer may be made into a membrane for gas separation. However, films or hollow filaments or fibers having a porous separation membrane, or substrate, and a coating in contact with the porous separation membrane are also contemplated. The polymers of the present invention may be used to make a mixed matrix membrane that includes a polymer or small, discrete molecular sieving entities or particles encapsulated in the polymer wherein the mixed matrix membrane contains, for example, a metal oxide. A mixed matrix membrane may also be used in the form of a dense film, tube or hollow fiber.

Two synthesis procedures are outlined herein, although the skilled artisan will readily understand other routes may be used. For example, several methods are possible to prepare polyimides, among them: the reaction between a dianhydride and a diamine and the reaction between a dianhydride and a diisocyanate. As an example of a procedure to prepare a poly(amic acid), which is a precursor to a polyimide that can be thermally rearranged to form a TR polymer, 3,3′-dihydroxy-4,4′-diamino-biphenyl (HAB) and dry N-methyl-2-pyrrolidone (NMP) (15 wt %) are added to a flame-dried 3-neck flask equipped with a mechanical stirrer, a N₂ purge, and a condenser. The HAB is dissolved in the NMP solvent, and the resulting solution is cooled to 0° C. Then an equimolar amount of a representative dianhydride, 2,2′-bis-(3,4-dicarboxyphenyl) hexafluoropropane dianhydride (6FDA), is added over a period of 30 minutes and the flask is rinsed to add all remaining 6FDA to the reaction solution, giving a 15% (w/v) mixture. The mixture is stirred and gradually heated to room temperature, forming a poly(amic acid).

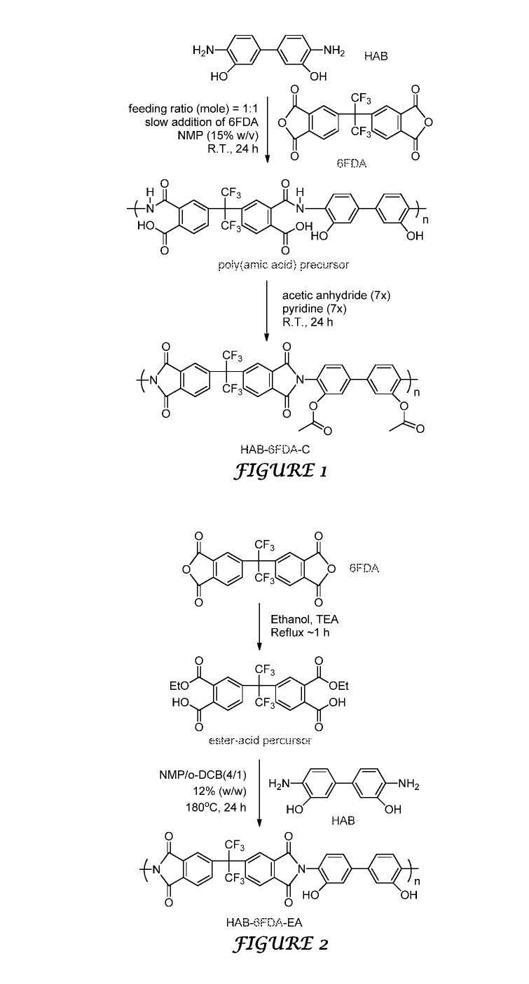

To perform chemical imidization, a 7 times excess (by mole) of acetic anhydride and pyridine is added to the poly(amic acid) solution. The solution is stirred at room temperature for 24 hours until forming precipitated polymers in methanol. The solution is then vacuum filtered, washed with methanol and air dried at 70° C. for 12 hours. HAB-6FDA polyimide is eventually produced after vacuum drying at 180° C. overnight. This procedure is outlined in FIG. 1.

An alternative method for synthesizing a polyimide by thermally imidizing an ester-acid precursor is also provided. A dianhydride monomer, 6FDA, is added to a 3-neck round bottom flask heated by an oil bath. The flask is equipped with a mechanical stirrer, N₂ purge, reverse Dean-Stark trap and reflux condenser. Then, 7-10 ml of absolute ethanol per gram of dianhydride is introduced along with 3 ml triethylamine as catalyst. The Dean Stark trap is filled with ethanol for refluxing purposes. The mixture is stirred for about an hour until a clear solution is obtained and the trap is drained. After distillation of the ethanol, the trap is drained again.

The trap is then filled with ortho-dichlorobenzene. HAB (equimolar with 6FDA), NMP and ortho-dichlorobenzene (5/1, v/v) are then added to give a solids content of 12% wt/v, and the mixture is heated to 175-185° C. for 24 hours before being precipitated in excess methanol. Vacuum filtration is performed to collect polymer fibers that are then washed with excess methanol and air dried at 70° C. for 12 hours and vacuum dried at 180° C. overnight into the final polymer. This procedure is outlined in FIG. 2.

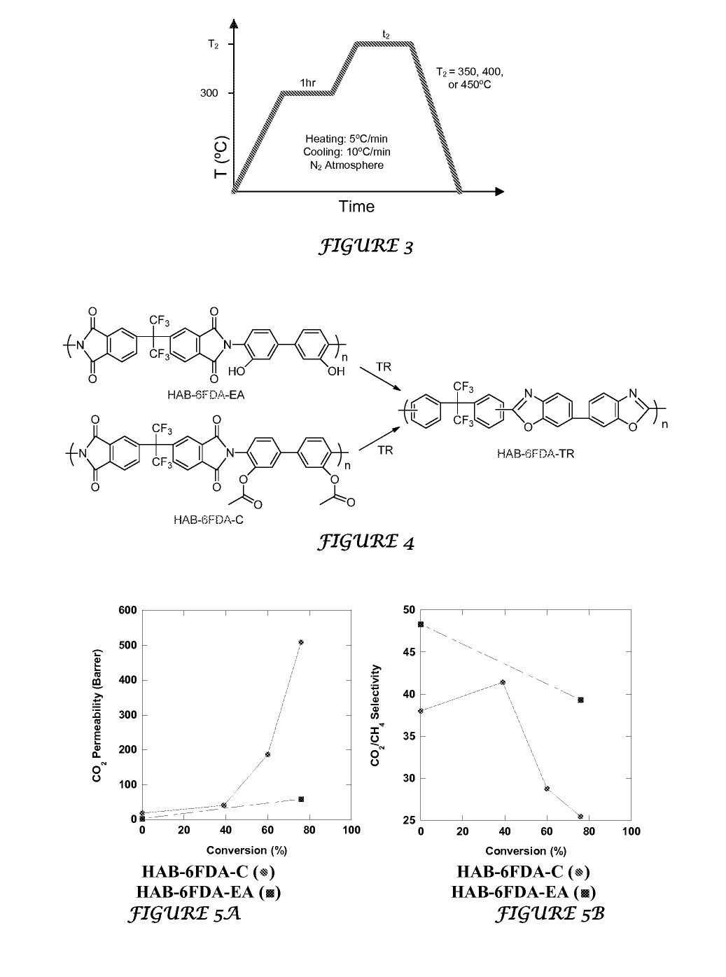

A method for thermally rearranging polyimides in the solid state is also provided. A Carbolite split-tube furnace, a 5° C./min heating rate and a 10° C./min cooling rate under a nitrogen atmosphere are used in addition to two isothermal regions: a first region with a 1 hour hold at 300° C. to ensure complete imidization and removal of residual casting solvent and a second region with a hold at the desired temperature for a desired amount of time to perform thermal rearrangement, thereby forming a thermally rearranged polymer. This procedure is outlined in FIG. 3. It is expected that the thermally rearranged polymer will have an identical structure after this rearrangement despite different synthesis routes, as shown in FIG. 4. Samples discussed below are often identified based on the temperature of the second region and the time that the sample was held at the temperature of the second region. For example, HAB-6FDA-TR400 (1 hour) would be an HAB-6FDA polyimide where the second region was a hold at 400° C. for 1 hour.

Film Casting. Polymer films are solution cast from NMP or dimethylacetamide (DMAc) depending on solubility. Other suitable solvents can be used, depending on the polymer. Solutions are filtered through a 0.45 μtm teflon syringe filter. After filtering, solutions are cast on to a glass substrate. Films are then dried in the air for 24 hours at 60° C., followed by vacuum drying at 200° C. for 24 hours.

Gel Fraction Measurement. Gel fraction measurements are conducted using a Soxhlet extractor. An accurately weighed dry film (W₀) is refluxed in DMAc. After 48 hours of extraction, the remaining undissolved film is collected and dried thoroughly before being accurately weighed again (W₁). Gel fraction is calculated according to the weights before and after extraction (i.e., gel fraction=W₁/W₀×100%).

Permeability results show that the synthesis route used to obtain a polyimide with an ortho-positioned functional group influences the transport properties of the corresponding TR polymer. The HAB-6FDA-TR400 (1 hour) polymer synthesized by chemical imidization has a CO₂ permeability approximately 2.5 times higher than that of an HAB-6FDA-TR400 (1 hour) polymer synthesized using the ester acid synthesis route. This increase in permeability is observed even though the polymer from the ester-acid synthesis route has a higher percent conversion to the final TR polymer structure, where percent conversion is defined by Equation 1.

$$\% Conversion = \frac{Actual Mass Loss}{Theoretical Mass Loss} \qquad ( 1 )$$

In Equation 1, the theoretical mass loss is that expected based upon complete conversion to the thermally rearranged structure, and the actual mass loss is that measured based upon weighing the sample before and after thermal rearrangement. The difference in the membrane performance is ascribed to the different ortho-position functional groups, i.e., hydroxyl group vs. acetate group.

FIGS. 5A and 5B are graphs of the CO₂ permeability and selectivity for HAB-6FDA and their corresponding TR products. FIG. 5A and FIG. 5B show the difference in permeability between the two polymers as a function of conversion to the final TR polymer structure. The permeability and selectivity show a significantly different behavior with respect to percent conversion despite the fact that these two polyimides theoretically rearrange to the same final structure, as shown in FIG. 4.

These materials also show different chemical resistance, which is a key factor in the attractiveness of thermally rearranged polymers as gas separation membrane materials. The table below shows the gel fraction, or insoluble fraction, of HAB-6FDA polymers prepared from polyimide precursors synthesized through ester acid (HAB-6FDA-EA) and chemical imidization (HAB-6FDA-C) routes for polymers thermally rearranged for one hour at 350° C. (TR350), 400° C. (TR400) and 450° C. (TR450). These results indicate that upon rearranging at 350° C. for 1 hour, the chemically imidized sample has significantly higher chemical resistance, as indicated by its much higher gel fraction.

| | TR350 | TR400 | TR450 |
|---|---|---|---|
| HAB-6FDA-EA | 3% | 98% | 100% |
| HAB-6FDA-C | 48% | 97% | 100% |

These results also introduce the possibility of tailoring the transport properties in TR polymers by varying the ortho-position functional group. It is hypothesized that larger functional groups create larger free volume elements in these high T_{g} materials during thermal rearrangement. For example, the ortho-position functional group could have a sulphur (S) linkage or an oxygen (O) linkage to a variety of functional groups with different sizes.

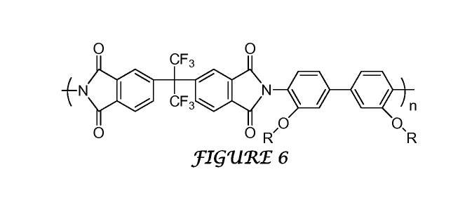

FIG. 6 is an image that shows a functional group R in a position which can be varied in the HAB-6FDA polyimide to tailor transport properties. This variation can be applied to other TR polymer precursors. Varying this ortho-position group that is partially lost during thermal rearrangement may impact the free volume and transport properties of the thermally rearranged product.

The present invention provides a polymer with the structure

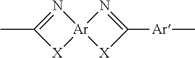

having ortho-functional group void spaces, where X can be O or S; Ar and Ar′ are aromatic moieties. The polymer is a thermally rearranged polyimide formed from a polyimide with an ortho-functional group that undergoes thermal rearrangement to form a polymer having an ortho-functional group void, wherein the thermally rearranged polymer has properties influenced by the ortho-functional group void. Example structures of Ar and Ar′ are presented in following Table, but any structure with similar functionality could work.

Ar
(from diamine)

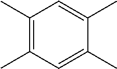

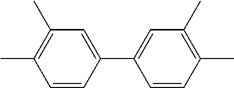

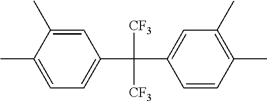

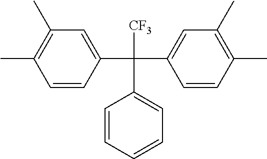

Ar′
(from dianhydride)

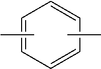

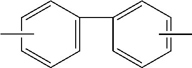

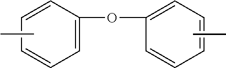

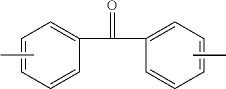

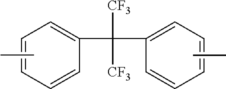

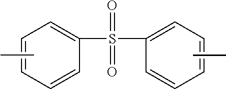

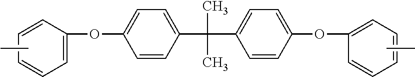

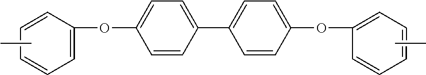

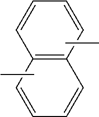

The present invention also includes a polymer membrane having an ortho-functional polyimide comprising 3,3′-dihydroxy-4,4′-diamino-biphenyl (HAB) diamine and 2,2′-bis-(3,4-dicarboxyphenyl) hexafluoropropane dianhydride (6FDA) that is thermally rearranged to form a gas separation membrane with a higher permeability for CO₂ and a higher CO₂/CH₄ selectivity and a strong chemical resistance preventing polymers from plasticizing in the presence of CO₂.

The present invention also includes an intermediate polyimide having ortho-functional groups (R):

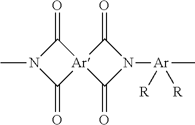

where Ar and Ar′ are aromatic moieties. The ortho-position groups (R) can be included with the original monomer, added through chemical imidization, or added with a post-imidization reaction. The intermediate polymer above includes ortho-functional groups that fill a specific region of space. The intermediate polyimide can then undergo rearrangement to form a polymer having ortho-functional group voids once occupied by the ortho-functional group. Example structures of Ar, Ar′ and R are presented in following table, but any group with this functionality could potentially work.

Ar
(from diamine)

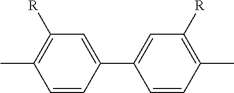

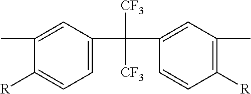

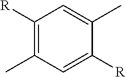

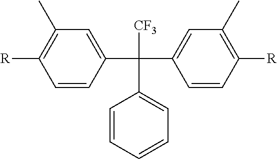

Ar′
(from dianhydride)

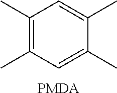

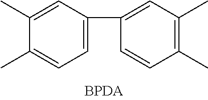

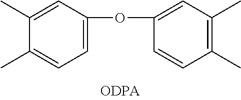

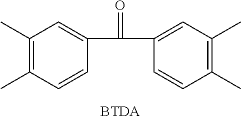

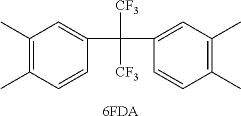

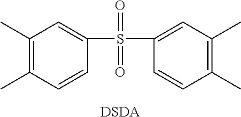

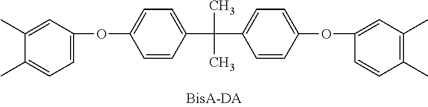

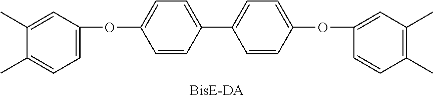

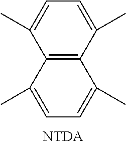

R
(ortho-functional group)
—OH, —SH

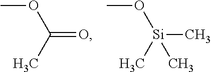

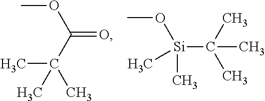

The present invention provides an aromatic polyimide with an ortho-functional group formed by imidization of the poly(amic acid). The method of synthesis of the polymer can also be used to dictate the properties of the aromatic polyimide and its corresponding TR polymer. In addition, the combination of the method of synthesis and the specific ortho-functional group can be used to dictate the properties of the final product. The aromatic polyimide with an ortho-functional group is rearranged to form a thermally rearranged polymer having an ortho-functional group void. The ortho-functional group has an O or S linkage to another group that is lost during rearrangement. The thermally rearranged polymer has free volume influenced by ortho-functional group voids with final transport properties influenced by this free volume.

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

1. Baker, R. W. and Lokhandwala, K., Natural gas processing with membranes: An overview. Industrial & Engineering Chemistry Research, 2008. 47(7): p. 2109-2121.

2. Kardash, I. Y., Ardashnikov, A. Y., Yakubovich, V. S., Braz, G. I., Yakubovich, A. Y., and Pravednikov, A. N., The kinetics of thermal cyclodehydration of aromatic poly-o-hydroxyaimdes to polybenzoxazoles. Vysokomol. soyed., 1966. A9(9): p. 1914-1919.

3. Kubota, T. and Nakanishi, R., Preparation of fully aromatic polybenzoxazoles. Polymer Letters, 1964. 2: p. 655-659.

4. Tullos, G. L. and Mathias, L. J., Unexpected thermal conversion of hydroxy-containing polyimides to polybenzoxazoles. Polymer, 1999. 40(12): p. 3463-3468.

5. Tullos, G. L., Powers, J. M., Jeskey, S. J., and Mathias, L. J., Thermal conversion of hydroxy-containing imides to benzoxazoles: Polymer and model compound study. Macromolecules, 1999. 32(11): p. 3598-3612.

6. Park, H. B., Jung, C. H., Lee, Y. M., Hill, A. J., Pas, S. J., Mudie, S. T., Van Wagner, E., Freeman, B. D., and Cookson, D. J., Polymers with cavities tuned for fast selective transport of small molecules and ions. Science, 2007. 318(5848): p. 254-258.

7. Choi, J. I., Jung, C. H., Han, S. H., Park, H. B., and Lee, Y. M., Thermally rearranged (TR) poly(benzoxazole-co-pyrrolone) membranes tuned for high gas permeability and selectivity. Journal of Membrane Science, 2010. 349(1-2): p. 358-368.

8. Han, S. H., Lee, J. E., Lee, K. J., Park, H. B., and Lee, Y. M., Highly gas permeable and microporous polybenzimidazole membrane by thermal rearrangement. Journal of Membrane Science, 2010. 357(1-2): p. 143-151.

9. Han, S. H., Misdan, N., Kim, S., Doherty, C. M., Hill, A. J., and Lee, Y. M., Thermally rearranged (TR) polybenzoxazole: Effects of diverse imidization routes on physical properties and gas transport behaviors. Macromolecules, 2010. 43(18): p. 7657-7667.

10. Eikner, O. M. and Fleming, G. K., Multicomponent or asymmetric gas separation membranes. 1998, L'Air Liquide, Societe Anonyme Pour L'Etude Et, L'Exploitation des Procedes Georges Claude (Paris, FR): United States patent.

What is claimed is:

1. A method for synthesizing a thermally rearranged polymer comprising the steps of:
forming a poly(amic acid) from at least one diamine monomer comprising an ortho-functional group and at least one dianhydride monomer;
forming an aromatic polyimide with an ortho-functional group by imidization of the poly(amic acid);
rearranging the aromatic polyimide with an ortho-functional group to form an aromatic polyimide having an ortho-functional group void, wherein the ortho-functional group includes an O or S linkage to second group that is lost and the aromatic polyimide having an ortho-functional group void has properties influenced by the ortho-functional group void.

2. The method of claim 1, wherein the imidization is a chemical imidization, a thermal imidization or a combination thereof.

3. The polymer made by the method of claim 1.

4. A method for synthesizing a thermally rearranged polymer comprising the steps of:
forming an aromatic polyimide having the structure: 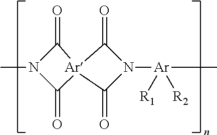
wherein Ar is a first aromatic group having an ortho-positioned functional group R₁ and R₂ and Ar′ is a second aromatic group; and heating the aromatic polyimide to a temperature between about 300° C. and about 550° C. and rearranging the polymeric film to form a thermally rearranged polymer having the structure: 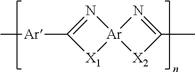
wherein X₁ and X₂ are either O or S and the thermally rearranged polymer has an ortho-positioned functional group voids.

5. The polymer made by the method of claim 4.

6. The method of claim 4, wherein the aromatic polyimide comprises a 3,3′-dihydroxy-4,4′-diamino-biphenyl (HAB) diamine and a 2,2′-bis-(3,4-dicarboxyphenyl)hexafluoropropane dianhydride (6FDA).

7. The method of claim 4, wherein the aromatic polyimide has the formula 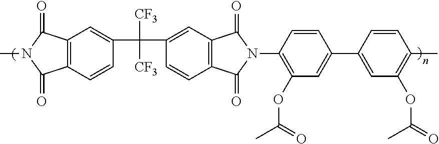
and the thermally rearranged polymer has the formula:

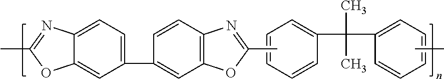

8. A method for synthesizing a thermally rearranged polybenzoxazole comprising the steps of:
forming an ortho-functionalized poly(amic acid) from a diamine monomer having ortho-positioned functional groups and a dianhydride monomer;
forming an ortho-functionalized polyimide with ortho-functional groups by imidization of the ortho-functionalized poly(amic acid); and
rearranging the ortho-functionalized polyimide with ortho-functional groups having an O or S linkage to a second group that is lost during rearrangement to form an rearranged polyimide having an ortho-functional group voids that influence the properties of the rearranged polyimide.

9. The polymer made by the method of claim 8.

10. The method of claim 8, wherein the diamine is a 3,3′-dihydroxy-4,4′-diamino-biphenyl (HAB) diamine and the dianhydride is a 2,2′-bis-(3,4-dicarboxyphenyl)hexafluoropropane dianhydride (6FDA).

11. A method for synthesizing a thermally rearranged polymer membrane comprising the steps of:
forming an ortho-functionalized poly(amic acid) from a diamine monomer having ortho-positioned functional groups and a dianhydride monomer;
forming an ortho-functionalized polyimide with ortho-functional groups by imidization of the ortho-functionalized poly(amic acid); casting the polyimide into a polymeric film; and
rearranging the ortho-functionalized polyimide with ortho-functional groups to form an rearranged polyimide having an ortho-functional group voids that influence the properties of the rearranged polyimide; and
drying the rearranged polyimide film.

12. The polymer made by the method of claim 11.

13. A polymer membrane comprising
a thermally rearranged polymer comprising an ortho-functional group void spaces formed by rearrangement of a polyimide with ortho-functional groups.

14. A method for synthesizing a thermally rearranged polybenzoxazole comprising the steps of:
combining a diamine and a dianhydride to form an ortho-functionalized poly(amic acid) having ortho-positioned functional groups;
cyclizing the ortho-functionalized poly(amic acid) having ortho-positioned functional groups with an imidization reaction; and
rearranging the ortho-functionalized polyimide with ortho-functional groups to form a rearranged polybenzoxazole having an ortho-functional group voids that influence the properties of the rearranged polyimide.

15. A method for synthesizing a thermally rearranged polymer comprising the steps of:
forming an poly(amic acid) from at least one diamine monomer comprising an ortho-functional group;
forming an aromatic polyimide with an ortho-functional group by chemical imidization of a poly(amic acid);
rearranging the aromatic polyimide with an ortho-functional group to form an aromatic polyimide having an ortho-functional group void, wherein the ortho-functional group includes an O or S linkage to second group that is lost and the aromatic polyimide having an ortho-functional group void has properties influenced by the ortho-functional group void and has higher gas permeability than an equivalent polymer that has been thermally imidized.

16. A method of post polymerization modification of a thermally rearranged polymer precursor comprising the steps of:
forming an aromatic polyimide by imidization of a poly(amic acid);
modifying the polyimide with one or more ortho-functional groups;
rearranging the aromatic polyimide with the ortho-functional group to form an aromatic polyimide having an ortho-functional group void, wherein the ortho-functional groups includes an O or S linkage to second group that is lost and the aromatic polyimide having an ortho-functional group void has properties influenced by the ortho-functional group void.

17. A method for synthesizing a thermally rearranged polymer comprising the steps of:
forming an aromatic polyimide having the structure: 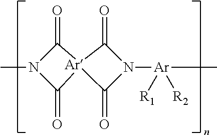
wherein Ar is a first aromatic group having an ortho-positioned functional group R₁ and R₂ and Ar′ is a second aromatic group; and
heating the aromatic polyimide to induce rearrangement; and
rearranging the polymeric film to form a thermally rearranged polymer having the structure: 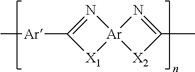
wherein X₁ and X₂ are either O or S and the thermally rearranged polymer has an ortho-positioned functional group voids.

18. The polymer made by the method of any of the above claims.

19. A polymer membrane comprising:
a thermally rearranged polymer comprising an ortho-functional group void spaces formed by rearrangement of a polyimide with ortho-functional groups, wherein the polyimide with ortho-functional groups comprises a diamine and a dianhydride to form an ortho-functionalized poly(amic acid) having ortho-positioned functional groups wherein the ortho-functionalized poly(amic acid) having ortho-positioned functional groups that has been cyclized with an imidization reaction and the ortho-functionalized polyimide with ortho-functional groups has been rearrange to form a rearranged polybenzoxazole having an ortho-functional group voids that influence the properties of the rearranged polyimide wherein the diamine and a dianhydride individually comprise a first aromatic selected from 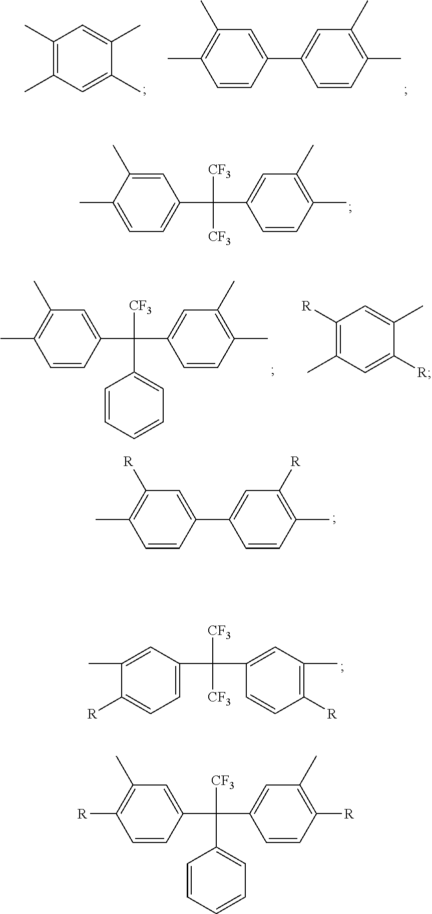
wherein R is 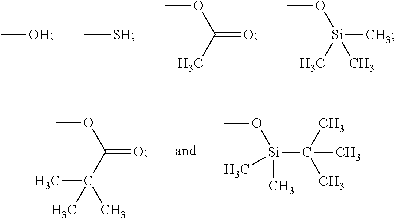
and a second aromatic selected from 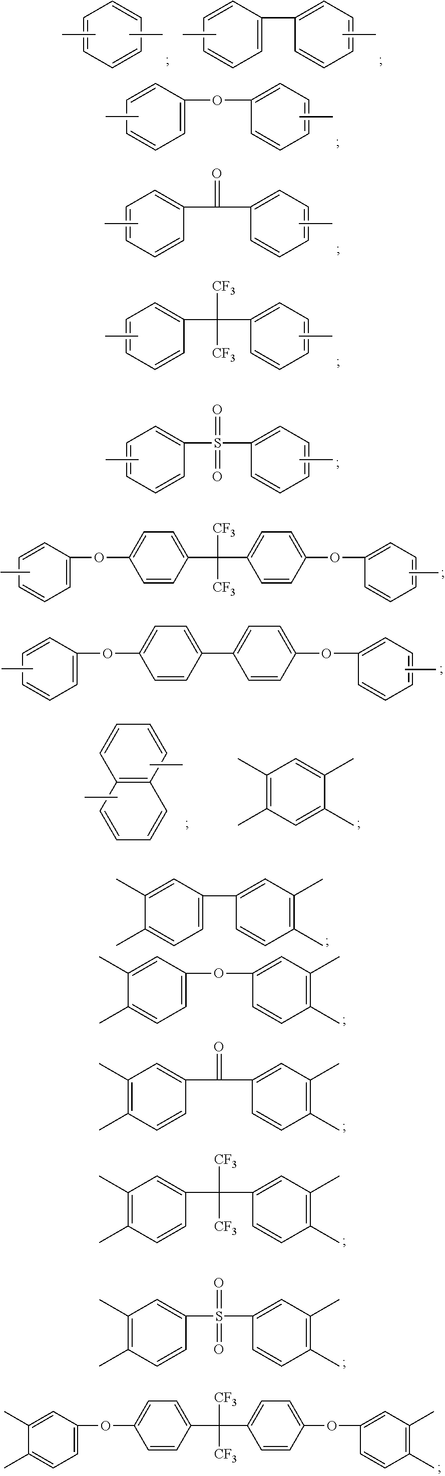 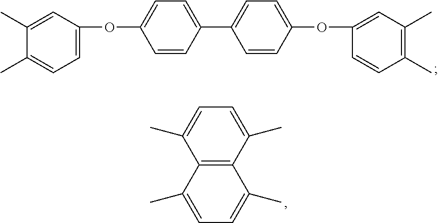
wherein R is [chemical structure]
